(19) United States
(12) Patent Application Publication
(10) Pub. No.: US 2012/0116964 A1
(43) Pub. Date: May 10, 2012

(54) Method and system of transaction cards management through business network

(75) Inventors: WeiCheng Tian, ShangHai (CN); Yi Dong, Shanghai (CN)

(73) Assignee: ONBEST TECHNOLOGY HOLDINGS LIMITED

(21) Appl. No.: 12/927,053

(22) Filed: Nov. 5, 2010

(51) Int. Cl. G06Q 40/00; G06Q 30/00; G06Q 20/00

(52) U.S. Cl. 705/41; 235/380; 235/379

(57) ABSTRACT

The present invention provides a system and a method for managing transaction cards through a business network, with which, the management and the deposit of transaction cards can be implemented any where and any time without carrying the transaction cards with card holders and without providing card holders' confidential information to card providers, and with which, card holders can manage transaction cards, make deposits and access and update card information of the transaction cards any where and any time without carrying the transaction cards with him/her and without providing card holders' confidential information to card providers, and with which, card providers can manage transaction cards and receive deposits any where and any time without requiring card holders' confidential information, wherein all the activities of transaction cards are recorded and reviewable.

### BACKGROUND OF THE PRESENT INVENTION

1. Field of Invention

The present invention relates to a method and system of information exchange between the providers and the holders of transaction cards, and more particularly to a method and system of transaction cards management through business network.

2. Description of Related Arts

In daily life many people own a lot of transaction cards (also called as business cards) and accounts apart from bank cards such as ATM card, debit card and credit card.

Such transaction cards and accounts are provided to persons by various businesses and organizations, such as commercial cards provided by beauty salon, restaurant, airline company, mall, chain stores, casino, and VIP membership card; the third-party payment platform account; pre-paid card for public traffic and communication such as bus and subway card, phone card, and pre-paid cell phone SIM card; payment card for utility such as water, gas, and electricity; social welfare card such as medical insurance, social insurance, public fund; and payment account for business and individual tax. These transaction cards always contain card information, such as account, serial number, period of validity, discount, point and credit, that these transaction cards are wildly used in daily life to indicate the membership, to record the using, to certificate the discount provided by businesses and to be charged for payment. As a result, all these transaction cards are designed to make convenience for people.

However, as more and more businesses and organizations are providing transaction cards, and even virtual ones only with accounts and without physical cards, it is already inconvenient and troublesome for people to deal with so many of them, as each card belongs to different business or organization. There is no a standard platform and interface to handle all those cards. The card holder has to deal with every business or organization individually.

Each transaction card, whatever transaction cards with or without physical cards, may have a serial number or account name and a password. The card holder has to carry all cards with him and remember all the serial number or account names and passwords. And for the transaction cards with points and/or credits, sometimes it is very inconvenient for the card holders to query the points and/or the remaining sum of the to cards and/or to make a deposit to the cards, and some could only be done through phone or in special service places of the card providers. Considering the inconvenience of carrying so many transaction cards and the difficulty of using the transaction cards with credits, some person may abandon some transaction cards which are not always used. This is a pity and a loss for both card providers and card holders. Also, many transaction cards store confidential information of card holders'. Once a transaction card is lost, personal information of the card holder may be used for illegal purposes.

Hence, it is very difficult to manager transaction cards for both card providers and card holders, and especially for the one traveling around the country and/or around the world.

### SUMMARY OF THE PRESENT INVENTION

The invention is advantageous in that it provides a system and a method for exchanging information between card providers and card holders of transaction cards.

Another advantage of the invention is to provide a system and a method for managing transaction cards through a business network.

Another advantage of the invention is to provide a system and a method for managing transaction cards based on a database.

Another advantage of the invention is to provide a system and a method for making deposit to transaction cards through a business network.

Another advantage of the invention is to provide a system and a method for making deposit to transaction cards based on a database.

Another advantage of the invention is to provide a secured system and a secured method for managing transaction cards, which do not need to provide card holders' confidential information to card providers.

Another advantage of the invention is to provide a secured system and a secured method for making deposit to transaction cards, which do not need to provide card holders' confidential information to card providers.

Another advantage of the invention is to provide a convenient system and a convenient method for managing transaction cards any where and any time.

Another advantage of the invention is to provide a convenient system and a convenient method for making deposit to transaction cards any where and any time.

Another advantage of the invention is to provide a system and a method for a card holder to manage transaction cards through a business network.

Another advantage of the invention is to provide a system and a method for a card holder to manage transaction cards therefore the card holder doesn't need to carry transaction cards with him/her.

Another advantage of the invention is to provide a secured system and a secured method for a card holder to manage transaction cards, which do not need to provide card holders' confidential information to card providers.

Another advantage of the invention is to provide a convenient system and a convenient method for a card holder to manage transaction cards any where and any time.

Another advantage of the invention is to provide a system and a method for a card holder to make deposit to transaction cards through a business network.

Another advantage of the invention is to provide a system and a method for a card holder to make deposit to transaction cards without carrying transaction cards with him/her.

Another advantage of the invention is to provide a secured system and a secured method for a card holder to make deposit to transaction cards, which do not need to provide card holders' confidential information to card providers.

Another advantage of the invention is to provide a convenient system and a convenient method for a card holder to make deposit to transaction cards any where and any time.

Another advantage of the invention is to provide a system and a method for a card holder to manage transaction cards wherein the card holder can access and update card information of the transaction cards through a business network.

Another advantage of the invention is to provide a system and a method for a card holder to manage transaction cards wherein the card holder can access and update card information of the transaction cards without carrying transaction cards with him/her.

Another advantage of the invention is to provide a secured system and a secured method for a card holder to manage transaction cards wherein the card holder can access and update card information of the transaction cards without providing card holders' confidential information to card providers.

Another advantage of the invention is to provide a convenient system and a convenient method for a card holder to manage transaction cards wherein the card holder can access and update card information of the transaction cards anywhere and any time.

Another advantage of the invention is to provide a system and a method for a card holder to manage transaction cards wherein all the activities of transaction cards are recorded and reviewable.

Another advantage of the invention is to provide a system and a method for a card provider to manage transaction cards through a business network.

Another advantage of the invention is to provide a system and a method for a card provider to manage transaction cards therefore the card provider doesn't need to check physical transaction cards.

Another advantage of the invention is to provide a secured system and a secured method for a card provider to manage transaction cards, which do not need to require card holders' confidential information.

Another advantage of the invention is to provide a convenient system and a convenient method for a card provider to manage transaction cards any where and any time.

Another advantage of the invention is to provide a system and a method for a card provider to receive deposit to transaction cards through a business network.

Another advantage of the invention is to provide a system and a method for a card provider to receive deposit to transaction cards without checking physical transaction cards.

Another advantage of the invention is to provide a secured system and a secured method for a card provider to receive deposit to transaction cards, which do not need to require card holders' confidential information.

Another advantage of the invention is to provide a convenient system and a convenient method for a card provider to receive deposit to transaction cards any where and any time.

Another advantage of the invention is to provide a system and a method for a card provider to manage transaction cards wherein all the activities of transaction cards are recorded and reviewable.

Another advantage of the invention is to provide a system and a method for managing transaction cards with at least one card provider terminal and at least on card holder terminal that card information could be transmitted between card provider terminals and card holder terminals to prove that the holders of card holder terminals have respective transaction cards of the holders of card provider terminals.

Another advantage of the invention is to provide a secured system and a secured method for managing transaction cards with at least one card provider terminal and at least on card holder terminal that card information could be transmitted between card provider terminals and card holder terminals to prove that the holders of card holder terminals have respective transaction cards of the holders of card provider terminals without requiring card holders' confidential information.

Another advantage of the invention is to provide a card holder terminal to manage a card holder's transaction cards.

Another advantage of the invention is to provide a card holder terminal to manage a card holder's transaction cards through business network.

Another advantage of the invention is to provide a card holder terminal to manage a card holder's transaction cards without carrying transaction cards with him/her.

Another advantage of the invention is to provide a card holder terminal to manage a card holder's transaction cards without providing the card holder's confidential information.

Another advantage of the invention is to provide a card holder terminal to manage a card holder's transaction cards any where and any time.

Another advantage of the invention is to provide a card holder terminal to make deposit to transaction cards.

Another advantage of the invention is to provide a card holder terminal to make deposit to transaction cards through business network.

Another advantage of the invention is to provide a card holder terminal to make deposit to transaction cards without carrying transaction cards with him/her.

Another advantage of the invention is to provide a card holder terminal to make deposit to transaction cards without providing the card holder's confidential information to card providers.

Another advantage of the invention is to provide a card holder terminal to make deposit to transaction cards any where and any time.

Another advantage of the invention is to provide a card holder terminal to manage a card holder's transaction cards wherein the card holder can access and update card information of the transaction cards anywhere and any time.

Another advantage of the invention is to provide a card holder terminal to manage a card holder's transaction cards wherein all the activities of transaction cards are recorded and reviewable.

Another advantage of the invention is to provide a card holder terminal, which could read card information from transaction cards and further store and use such card information to replace transaction cards.

Another advantage of the invention is to provide a card holder terminal to manage a card holder's transaction cards wherein all the activities of transaction cards are recorded and reviewable.

Another advantage of the invention is to provide a card holder terminal to make deposit to transaction cards wherein all the activities of transaction cards are recorded and reviewable.

Another advantage of the invention is to provide a card holder terminal, which could read card information stored in external memories and further store and use such card information to replace transaction cards.

Another advantage of the invention is to provide a card holder terminal, which could copy card information stored therein into external memories, which could be used as a backup or be used in another card holder terminal.

Another advantage of the invention is to provide a card provider terminal for a card provider to manage transaction cards through a business network.

Another advantage of the invention is to provide a card provider terminal for a card provider to manage transaction cards therefore the card provider doesn't need to check physical transaction cards.

Another advantage of the invention is to provide a card provider terminal for a card provider to manage transaction cards, which do not need to require card holders' confidential information.

Another advantage of the invention is to provide a card provider terminal for a card provider to manage transaction cards any where and any time.

Another advantage of the invention is to provide a card provider terminal for a card provider to receive deposit to transaction cards through a business network.

Another advantage of the invention is to provide a card provider terminal for a card provider to receive deposit to transaction cards without checking physical transaction cards.

Another advantage of the invention is to provide a card provider terminal for a card provider to receive deposit to transaction cards, which do not need to require card holders' confidential information.

Another advantage of the invention is to provide a card provider terminal for a card provider to receive deposit to transaction cards any where and any time.

Another advantage of the invention is to provide a card provider terminal for a card provider to manage transaction cards wherein all the activities of transaction cards are recorded and reviewable.

Additional advantages and features of the invention will become apparent from the description which follows, and may be realized by means of the instrumentalities and combinations particular point out in the appended claims.

According to the present invention, the foregoing and other objects and advantages are attained by a system for managing transaction cards, comprising one or more card holder terminals, one or more card provider terminals, a management control, a database connected with the management control and containing card information of transaction cards, and a business network linking the card holder terminals, the card provider terminals with the management control. The card holder terminals connect with the card provider terminals wirelessly. The card holder terminals obtain and store card information of transaction cards and send the card information to the card provider terminals. The card provider terminals receive the card information from the card holder terminals and send the card information to the management control. The management control receives the card information from the card provider terminals and checks the card information with card information stored in the database, the management control sends checking results to the card provider terminals.

In accordance with another aspect of the invention, the management control of the system for managing transaction cards connects with one or more bank networks, to which the card holder terminal sends a request for deposit directly or indirectly through the business network to transact predetermined amount of money to respective card holder account or to one or more respective card accounts of transaction cards.

In accordance with another aspect of the invention, the present invention comprises a method of managing transaction cards, comprising the steps of:

(a) providing a business network;

(b) providing a database containing card information of transaction cards;

(c) sending card information stored in one or more card holder terminals to one or more card provider terminals;

(d) sending card information received to a management control through the business network by the card provider terminals;

(e) checking card information received with card information stored in the database by the management control;

(f) sending checking result to the card provider terminals by the management control.

In accordance with another aspect of the invention, the method of managing transaction cards further comprises a step of transacting predetermined amount of money to respective card holder account of card holder or to one or more respective card accounts of transaction cards.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a system for managing transaction cards according to a preferred embodiment of the present invention.

FIG. 2 is a block diagram of a card holder terminal of the system for managing transaction cards according to above preferred embodiment of the present invention.

FIG. 3 is a block diagram of a card provider terminal of the system for managing transaction cards according to above preferred embodiment of the present invention.

FIG. 4 is a block diagram of the system for managing transaction cards according to above preferred embodiment of the present invention.

FIG. 5 is a block diagram of a database of the system for managing transaction cards according to above preferred embodiment of the present invention.

FIG. 6 is a flow chart of a method of managing transaction cards according to above preferred embodiment of the present invention.

FIG. 7 is a flow chart illustrating the step of uploading card information of the method of managing transaction cards according to above preferred embodiment of the present invention.

FIG. 8 is a flow chart illustrating the step of linking respective card account with a card holder account of the method of managing transaction cards according to above preferred embodiment of the present invention.

FIG. 9 is a flow chart illustrating the step of downloading card information of the method of managing transaction cards according to above preferred embodiment of the present invention.

FIG. 10 is a flow chart illustrating the step of checking card information with card information stored in a database of the method of managing transaction cards according to above preferred embodiment of the present invention.

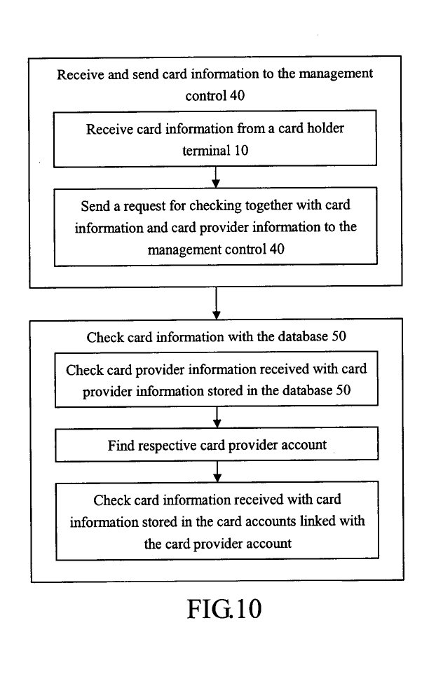

FIG. 11 is a flow chart illustrating the step of transacting predetermined amount of money to respective card holder account of card holder or to one or more respective card accounts of transaction cards of the method according to above preferred embodiment of the present invention.

### DETAILED DESCRIPTION OF THE PREFERRED EMBODIMENT

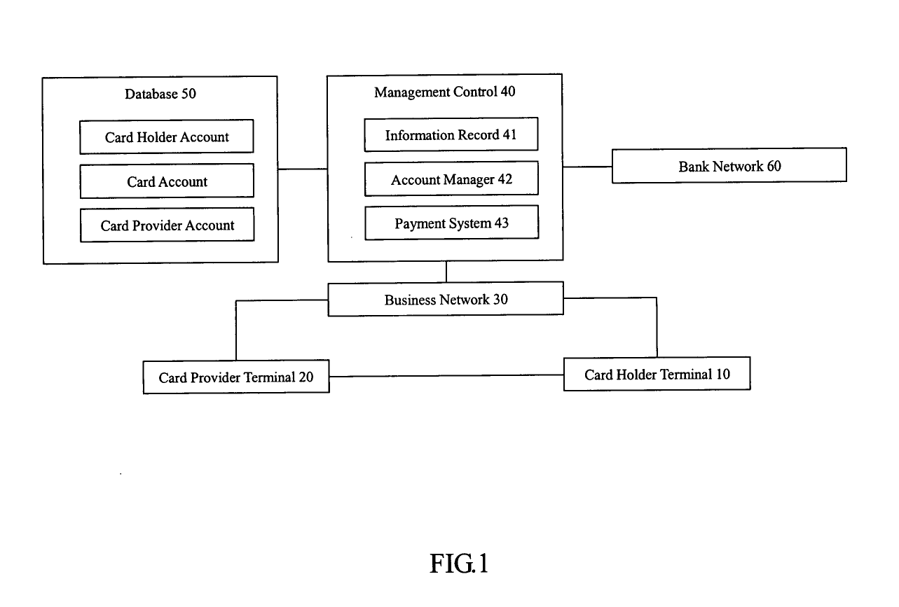

Referring to FIG. 1, a system for managing transaction cards according to a preferred embodiment of the present invention is illustrated, wherein the system for managing transaction cards comprises one or more card holder terminals 10, one or more card provider terminals 20, a management control 40, a database 50 connected with the management control 40 and containing card information of transaction cards, and a business network 30 linking the card holder terminals 10, the card provider terminals 20 with the management control 40, wherein the card holder terminals 10 are communicatively linked with the card provider terminals 20.

The card holder terminals 10 obtain and store card information of transaction cards and send the card information to the card provider terminals 20, and the card provider terminals 20 receive the card information from the card holder terminals 10 and send the card information to the management control 40. The management control 40 receives the card information from the card provider terminals and checks the card information with card information stored in the database 50, and the management control 40 sends checking results to the card provider terminals 20.

Referring to FIG. 1, the database 50 contains one or more card accounts storing card information of transaction cards, one or more card provider accounts storing card provider information of the ones who give transaction cards, and one or more card holder accounts storing card holder information of the ones who are given transaction cards, wherein each card account is linked with respective card provider accounts and with respective card holder accounts.

Referring to FIG. 1, the management control 40 comprises:

an information record 41 receiving card information from the card provider terminals 20 and storing card information in the database 50;

an account manager 42 checking card information, card holder information and card provider information received with card information, card holder information and card provider information stored in the database 50 to find respective card accounts, card holder account and card provider accounts.

For each card provider, there is a corresponding card provider information stored in a respective card provider account in the database 50, wherein the card provider information can be stored in a card provider terminal 20 or be inputted through a card provider terminal 20 by the card provider, wherein the card provider information represents the card provider and is used to identify the card provider. The card provider information can be a serial number and a code, or be encryption key, or other suitable manners which could be used to identify a card provider.

For each card holder, there is a corresponding card holder information stored in a respective card holder account in the database 50, wherein the card holder information represents the card holder and is used to identify the card holder. The card holder information can be a serial number and a code, or be encryption key, or other suitable manners which could be used to identify a card holder.

For each transaction card, there is a corresponding card information stored in a respective card account in the database 50, wherein the card information includes a serial number (an account number), a cord and business information, such as discount, use times, period of validity, point and credit, wherein the card information is stored in a transaction card provided by a card provider to a card holder, wherein the business information can be updated and the code can be amended by a card holder. Some transaction cards only contains a serial number and business information, and some transaction cards are actually virtual cards only with a serial number (an account number), a code and business information without physical card. For a transaction card, the serial number and the business information are given by a card provider and are recorded in a respective card account in the database 50 by the card provider, while the code is given by a card holder and is recorded in the card account in the database 50. As a result, the card account in the database 50 contains the serial number, the code and the business information of the transaction card. And the card information can be stored in a card holder terminal 10, wherein the serial number and the business information are stored in the card holder terminal 10 and the code (if have) can be stored in the card holder terminal 10 or be inputted when required.

When using a transaction card, the card holder selects the transaction card and sends its card information to the card provider's card provider terminal 20 by a card holder terminal 10, wherein the card information sent can includes only a serial number or includes other suitable information. The card provider terminal 20 receives the card information and forwards the card information to the management control 40. The account manager 42 checks the card information received with card information stored in the database 50 to find the respective card account, for example such check can be done in such a manner that the account manager 42 checks the serial number of the card information with all the serial number stored in all the card account and finds a corresponding card account containing a coincident serial number. And the business information stored in this card account can be sent to the card provider terminal 20 as a checking result to show discount, use times, period of validity, point, credit and any other information of the transaction card.

That means card information of a transaction card is stored in a card account in the database 50 and some information, like a serial number, of the card information are used as a key to find the card account. The card provider information, the card provider account, the card holder information and the card holder account are implemented in the same manner. The card provider information includes a serial number, a code and other business information, such as bank account information, and is stored in a card provider account in the database 50, and then some information, like the serial number or like the serial number together with the code, is used as key to find the card provider account. The card holder information includes a serial number, a code and other business information, such as bank account information, and is stored in a card holder account in the database 50, and then some information, like the serial number or like the serial number together with the code, is used as key to find the card holder account.

Hence, for each card provider providing transaction cards, there is a respective card provider account established in the database 50 and respective card accounts storing card information of transaction cards which have already been provided by such card providers stored in the database 50, wherein such card information are linked with the card provider account. Additionally, for each person provided with transaction cards, there is respective card holder account established in the database 50 and respective card information of transaction cards which have already been provide to such person stored in the database 50, wherein such card information are linked with the card holder account. That means, for a transaction card provided to a person by a business, in the database 50, there is card information of this transaction card and such card information is linked with respective card provider account of this business and with respective card holder account of this person.

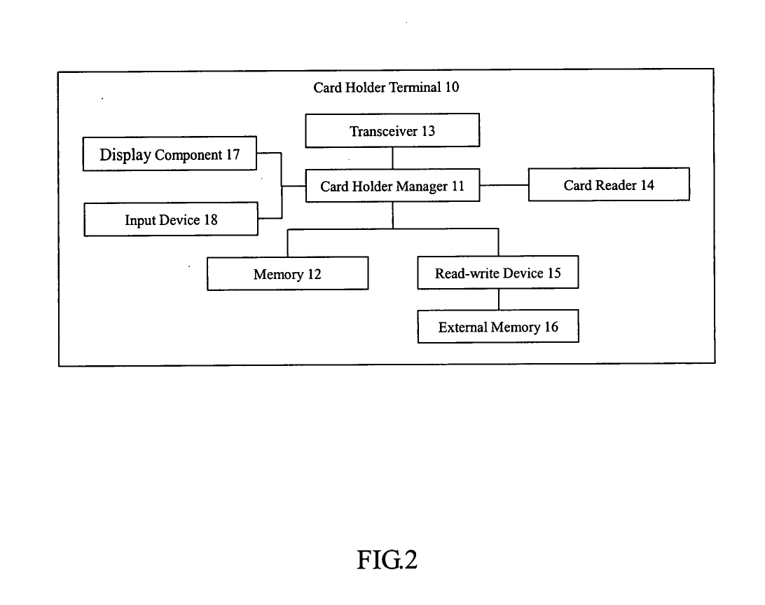

Referring to FIG. 2, the card holder terminal 10 of the system for managing transaction cards according to above preferred embodiment of the present invention is illustrated, wherein the card holder terminal 10 comprises:

a memory 12 storing card information;

a transceiver 13 sending card information stored in the memory 12 to the card provider terminals 20 and receiving card information from the card provider terminals 20 and/or from the database 50 through the management control 40; and

a card holder manager 11 connected with the memory 12 and the transceiver 13 and managing the memory 12 and the transceiver 13.

The card holder manager 11 manages card information received by the transceiver 13 to be stored in the memory 12, and the card holder manager 11 manages card information stored in the memory 12 to be selected and to be sent by the transceiver 13 with a use record of the card information recorded in the memory 12.

Referring to FIG. 2, the card holder terminal 10 further comprises a card reader 14 connected with the card holder manager 11 and reading card information from a transaction card, which is further transmitted to the card holder manager 11 and stored in the memory 12.

Referring to FIG. 2, the card holder terminal 10 further comprises a read-write device 15 connected with the card holder manager 11 and reading card information stored in an external memory 16, which is further transmitted to the card holder manager 11 and stored in the memory 12, wherein the card holder manager 11 manages card information stored in the memory 12 to be copied to an external memory 16 with the read-write device 15.

Here, the card information of a transaction card could be obtained by a card holder terminal 10 in three manners:

the first manner that the card information could be transmitted from the card provider terminal 20 to the card holder terminal 10, which is particularly adapted to virtual cards;

the second manner that the card information could be red from the transaction card by the card holder terminal 10, which is particularly adapted to physical cards;

the third manner that the card information could be red from an external memory by the card holder terminal 10, wherein the card information stored in the external memory can be written by a card provider terminal 20 or by a card holder terminal 10 like backups or by other suitable equipments.

Referring to FIG. 2, the card holder terminal 10 further comprising a display component 17 connected with the card holder manager 11, wherein the display component 17 displays card information identifying cards to select from.

Referring to FIG. 2, the card holder terminal 10 further comprises an input device 18 connected with the card holder manager 11 for inputting card holder information and/or card holder's identification information. For security, the card holder terminal 10 does not store some card holder information, like serial number and code, and especially does not store card holder's identification information therein. Hence, when these kinds of information are required, the card holder can input information by the input device 18. Hence, even when a card holder terminal 10 is lost, no personal identification information might be divulged.

Referring to FIG. 2, the card holder manager 11 further comprises an encrypting unit operatively linked with the transceiver 13 for encrypting information before sending out, such as to the card provider terminals 20 and/or the management control 40.

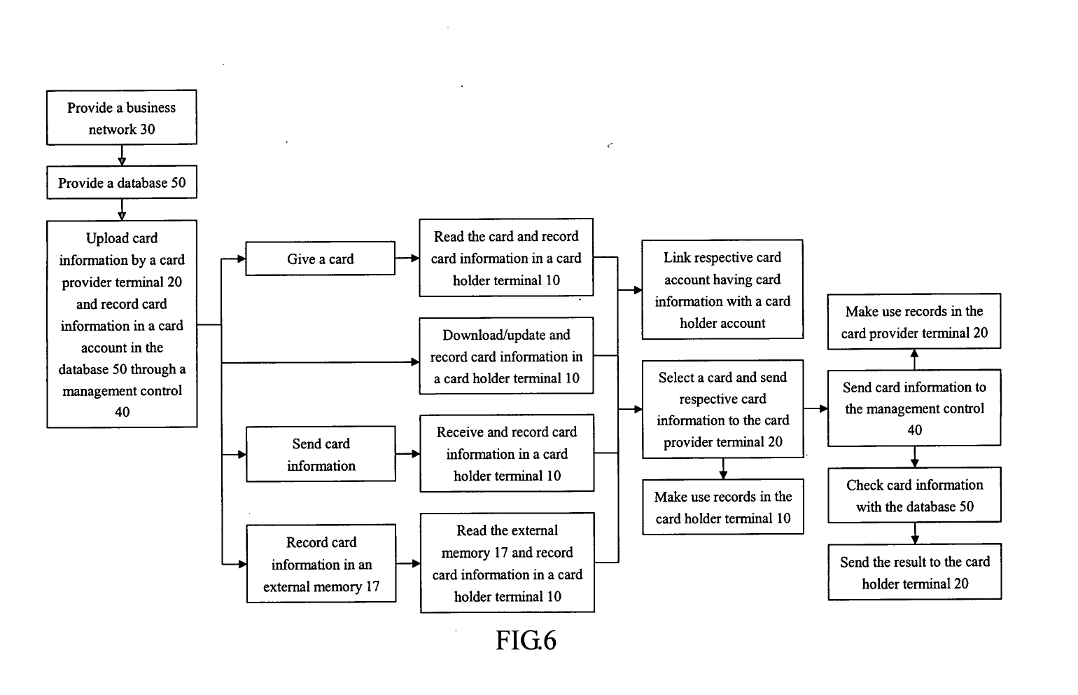

Referring to FIG. 6 to FIG. 9, a business network 30 is established and a database 50 containing one or more card provider accounts and one or more card holder accounts is established. When a card provider is providing a transaction card (physical card or virtual card) to a person, the card provider terminal 20 manages the establishment of card information in the database 50.

The card provider terminal 20 sends a request for establishing card account together with card information and card provider information to the management control 40, when the account manager 42 of the management control 40 receives this request, the account manager 42 checks the card provider information received with card provider information stored in the database 50 to find respective card provider account, the information record 41 establishes a card account in the database 50, records the card information received in this card account and links this card account with the respective card provider account.

And after the card holder terminal 10 obtains this card information, the card holder terminal 10 could send a request for link together with this card information and the card holder information to the management control 40, when the account manager 42 of the management control 40 receives the request, the account manager 42 checks the card holder information received with card holder information stored in the database 50 to find respective card holder account, the account manager 42 checks this card information received with card information stored in card accounts in the database 50 to find respective card account in the database 50, and then the information record 41 links the respective card account with the respective card provider account.

Until now, the card account is established in the database 50 and is linked with respective card provider account and respective card holder account.

After the card information of the transaction card is uploaded to the database 50, the card information could be obtained by the card holder terminal 10 in various ways.

If there is a transaction card (physical card) provided to a card holder by a card provider, the card reader 14 of the card holder terminal 10 reads the card information from the transaction card and then the card information are stored in the memory 12 under the control of the card holder manager 11.

The card provider terminal 20 could send the card information of the transaction card directly to the card holder terminal 10, and the card information will be received by the transceiver 13 of the card holder terminal 10 and then be stored in the memory 12 under the control of the card holder manager 11.

The card information could be written into an external memory 17 by the card provider terminal 10 or by another card holder terminal having this card information. Then the read-write reader 14 of the card holder terminal 10 reads the card information from the external memory 17 and then the card information are stored in the memory 12 under the control of the card holder manager 11.

Alternatively, the card information could be downloaded/update to the card holder terminal 10 from the database 50. The card holder manager 11 manages the transceiver 13 to send the card holder information to the management control 40 by the transceiver 13 and a request for downloading/updating card information from the database 50. When the account manager 42 receives the request for downloading/updating card information sent by the card holder terminal 10, the account manager 42 checks card holder information sent by the card holder terminal 10 with card holder information stored in the database 50 to find respective card holder account and then sends card information stored in card accounts linked with the respective card holder account to the card holder terminal 10, the card information downloaded/updated from the database 50 is substantially received and stored in the card holder terminal 10.

Until now, the card information is obtained and stored in the card holder terminal 10. When the person would like to use the transaction card, he/she only need to select the respective transaction card on the card holder terminal. The card holder manager 11 manages the display component 17 to display card information stored in the memory 12 identifying cards for selection, and then the card holder manager 11 manages the transceiver 13 to send the card information of the selected card to the card provider terminal 20.

When the card provider terminal 20 receives card information from the card holder terminal 10, the card provider terminal 20 sends a request for checking together with the card information received and the card provider information to the management control 40, when the account manager 42 of the management control 40 receives the request, the account manager 42 checks the card provider information received with card provider information stored in the database 50 to find respective card provider account and then further checks the card information received with card information stored in card accounts linked with the card holder accounts to find the respective card account. And then the management control 40 sends the checking result to the card provider terminal 20. And this time the card provider will know if the person holding the card holder terminal 10 has a transaction card provided by the card provider and will know the status and other information of such transaction card, such as the period of validity, the discount and so on.

Additionally, the card holder terminal 10 could make use records of card information and store the use records in the memory 12.

Additionally, the card information and the use records stored in the memory 12 of the card holder terminal 10 could be copied into an external memory 17 through the read-write device 15 under the control of the card holder manager 11. At this time, the card information and the use records are exported from the card holder terminal 10 to form a backup.

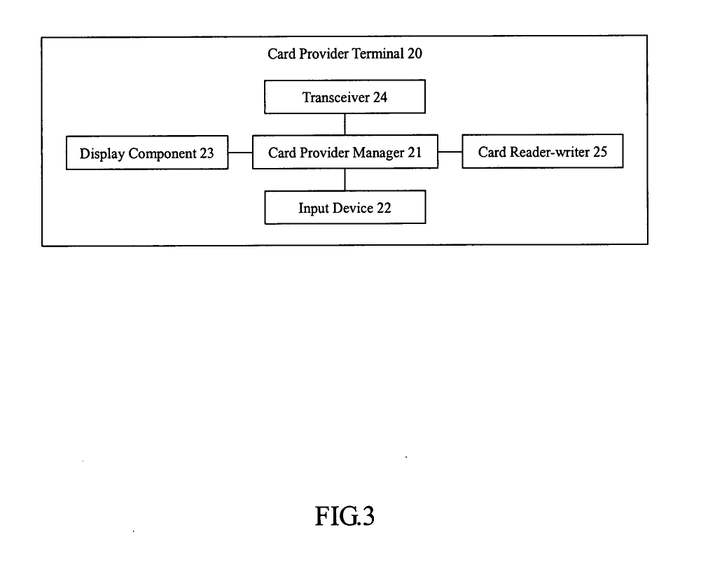

According to the above preferred embodiment of the present invention, the card provider terminal 20 could receive and send information, and could manages the establishment of card information in the database 50. Referring to FIG. 3, the card provider terminal 20 of the system for managing transaction cards according to above preferred embodiment of the present invention is illustrated, wherein the card provider terminal 20 comprises:

a transceiver 13 receiving and sending card information, card provider information and card holder information;

an input device 22 for inputting card information;

an card reader-writer 25 reading card information from a transaction card or writing card information into a transaction card;

a display component 23 displaying card information and the checking result; and

a card provider manager 21 connecting with and managing the transceiver 24, the input device 22, the card reader-writer 25 and the display component 23.

Card information of a transaction card could be inputted by the input device 22 and further be uploaded to the database 50. Alternatively, such card information could be written into a transaction card by the card reader-writer 25 and further be provided to a person for use. Alternatively, such card information could be sent to the card holder terminal 10 as a virtual card.

Alternatively, card information could be red from a transaction card pre-storing card information therein by the card reader-writer 25 and further be uploaded to the database 50. And then the transaction card pre-storing card information could be provided to a person for use. Alternatively, such card information could be sent to the card holder terminal 10 as a virtual card.

Referring to FIG. 1, the management control 40 further connects with one or more bank networks 60, to which the card holder terminal 10 sends a request for transferring directly or indirectly through the business network 30 to transfer certain money to one or more respective transaction card and to update respective card information stored in the database 50.

The management control 40 further comprises a payment system 43 managing requests for transferring. When the card holder terminal 10 sends a request for transferring together with one or more card information and a bank account information to the management control 40, and when the management control 40 receives the request, the account manager 42 checks card information sent by the card holder terminal 10 with card information stored in the database 50 to find respective card information, and the payment system 43 checks the bank account information and forwards the bank account information to respective bank through the bank network 60 to transfer certain money, and then the account manager respectively updates card information stored in the database.

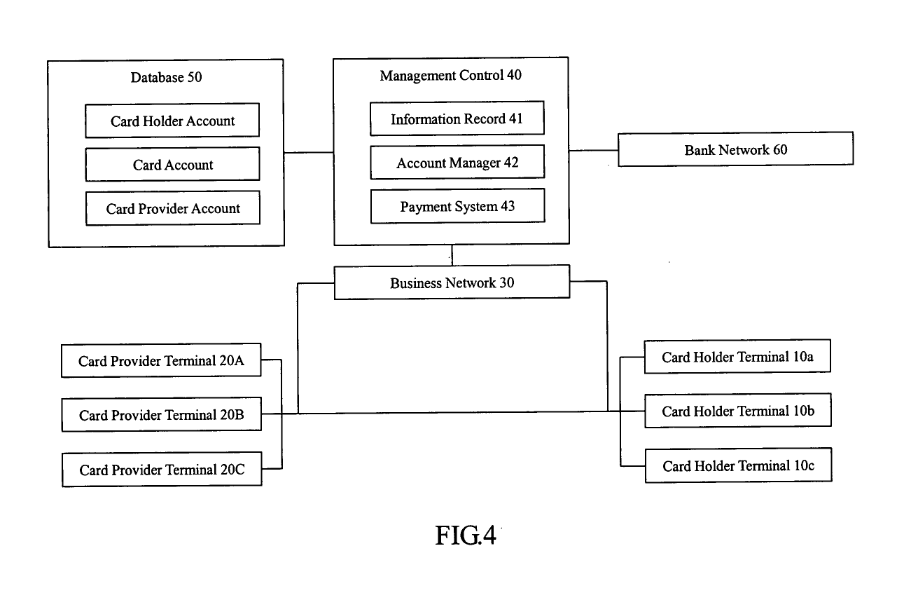

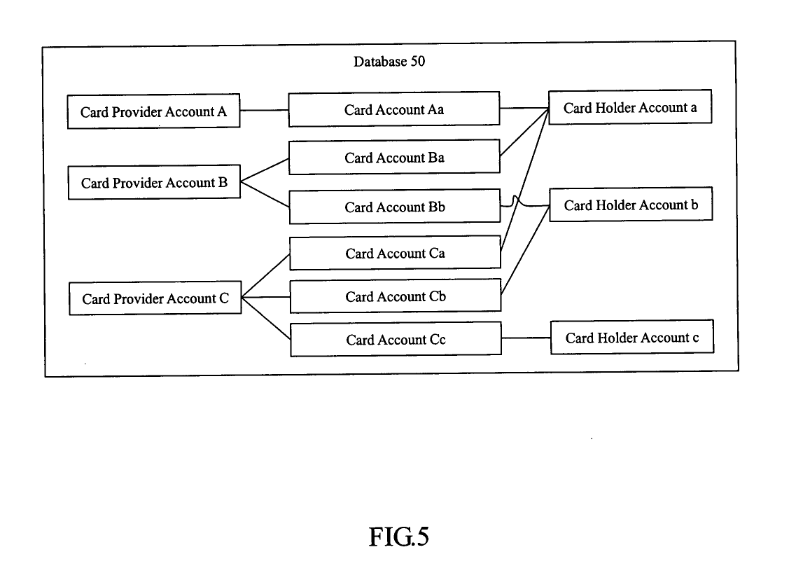

Referring to FIG. 4, the system for managing transaction cards according to above preferred embodiment of the present invention with more than one card holder terminals 10 more than one card provider terminals 20 is illustrated, wherein the respective database 50 of the system in FIG. 4 is illustrated in FIG. 5.

Referring to FIG. 4 and FIG. 5, take the system for managing transaction cards according to above preferred embodiment of the present invention as a example, wherein the system comprises three card holder terminals 10a, 10b and 10c, and three card provider terminals 20A, 20B and 20C, wherein the database 50 of the system comprises three card holder accounts a, b and c, and three card provider accounts A, B and C.

The card holder terminals 10a, 10b and 10c are connected with the business network 30, the respective card holder information of which are respectively stored in the card holder account a, b and c in the database 50.

The card provider terminals 20A, 20B and 20C are connected with the business network 30, the respective card provider information of which are respectively stored in the card provider account A, B and C in the database 50.

The card holder terminals 10a, 10b and 10c and the card provider terminals 20A, 20B and 20C could be connected with each other wirelessly to transmit information.

Referring to FIG. 5, for a transaction card provided to person a by card provider A, the card account Aa storing card information of such card is linked with the card provider account A of such card provider A and with the card holder account a of such card holder a. A card holder account could be directly linked with one or more card accounts and be indirectly linked with one or more card provider accounts. Similarly, a card provider account could be directly linked with one or more card accounts and be indirectly linked with one or more card holder accounts. However, one card account storing card information of a transaction card is usually linked with one card holder account and one card provider account, expect that the transaction card is provided to more than one card holder or is provided by more than one card provider. And in this situation, such card account will be linked with each card holder account of the card holders provided with the transaction card or be linked with each card provider account of the card providers providing the transaction card.

In a more preferred embodiment of the present invention, the card holder terminal 10, the card provider terminal 20, the business network 30, the management control 40, the database 50 and the bank network 60 are connected with each other wirelessly.

Referring to FIG. 1, the management control 40 further connects with one or more bank networks 60, to which the card holder terminal 10 sends a request for deposit directly or indirectly through the business network 30 to transact predetermined amount of money to respective card holder account or to one or more respective card accounts of transaction cards, wherein the management control 40 further comprises a payment system 43 managing requests for deposit.

When the card holder terminal 10 sends a request for transacting predetermined amount of money together with card holder information and a bank account information to the management control 40, and when the management control 40 receives the request, the account manager 42 checks card holder information sent by the card holder terminal 10 with card holder information stored in the database 50 to find respective card holder account, and the payment system 43 checks the bank account information and forwards the bank account information to respective bank through respective bank network 60 to transact predetermined amount of money to the card holder account.

When the card holder terminal 10 sends a request for transacting predetermined amount of money together with card holder information, card information and a bank account information to the management control 40, and when the management control 40 receives the request, the account manager 42 checks card holder information sent by the card holder terminal 10 with card holder information stored in the database 50 to find respective card holder account and checks card information sent by the card holder terminal 10 with card information stored in card accounts linked with the card holder account to find respective card account, and the payment system 43 checks the bank account information and forwards the bank account information to respective bank through respective bank network 60 to transact predetermined amount of money to the card account.

When the card holder terminal 10 sends a request for transacting predetermined amount of money together with card holder information and card information to the management control 40, and when the management control 40 receives the request, the account manager 42 checks card holder information sent by the card holder terminal 10 with card holder information stored in the database 50 to find respective card holder account and checks card information sent by the card holder terminal 10 with card information stored in card accounts linked with the card holder account to find respective card account, and the payment system 43 transact predetermined amount of money from the card holder account to the card account.

As mentioned above, the system implements the deposits, such as transacting predetermined amount of money from a bank account to a card holder account, or from a bank account to a card account of a card holder, or from a card holder account to a card account of the card holder.

In the deposit procedure mentioned above, the bank account information can be inputted through the card holder terminal 10 by the input device 18, or can be red from a bank card by the card reader 14. As a result, neither bank account information nor personal identification information is stored in the card holder terminal 10 or is provided to the card provider in the deposit procedure. Hence, a security deposit is implemented.

Additional, along the using of transaction card, predetermined amount of money might be transacted from card accounts of some transaction cards to respective card provider accounts to make consumption.

Referring to FIG. 6, a method of managing transaction cards according to above preferred embodiment of the present invention is illustrated, wherein the method comprises the steps of:

(a) providing a business network 30;

(b) providing a database 50 containing card information of transaction cards;

(c) sending card information stored in one or more card holder terminals 10 to one or more card provider terminals 20;

(d) sending card information received to a management control 40 through the business network 30 by the card provider terminals 20;

(e) checking card information received with card information stored in the database 50 by the management control 40;

(f) sending checking result to the card provider terminals 20 by the management control 40.

Referring to FIG. 6, the step (c) further comprises a step (c1) of obtaining card information by the card holder terminal 10 before the step of sending card information.

Referring to FIG. 6, the method further comprises a step (b1) of uploading card information to the database 50 through the management control 40 by the card provider terminal 20 between the step (b) and the step (c), or between the step (b) and the step (c1).

The step (b1) is used to upload card information of a transaction card to the database 50 before providing the transaction card to a card holder by a card provider, and is used to establish a card account for the card information for further use.

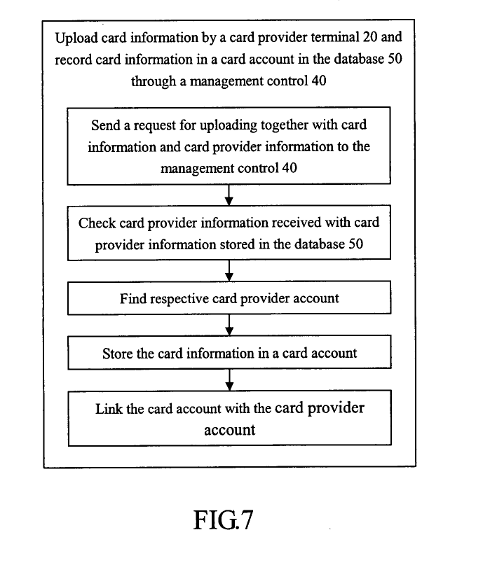

Referring to FIG. 7, the step (b1) further comprises the steps of:

sending a request for uploading together with card information and card provider information to the management control 40 by the card provider terminal 20;

checking card provider information received with card provider information stored in the database 50 to find respective card provider account by the account manager 42;

storing card information in a card account and linking the card account with the card provider account by the information record 43 of the management control 40.

After the card information of a transaction card is uploaded and a respective card account is established in the step (b1), this card information is needed to be obtained by the card provider terminal 10 of the card holder in the step (c1).

Referring to FIG. 6, the step (c1) can be done in three ways, i.e., alternatively the step (c1) is selected from:

sending card information to the card holder terminal 10 by the card provider terminal 20 and storing acquired card information in the card holder terminal 10 for use;

reading card information from a transaction card with a card reader 14 of the card holder terminal 10 and storing acquired card information in the card holder terminal 10 for use;

reading card information stored in an external memory with a read-write device 15 of the card holder terminal 10 and storing acquired card information in the card holder terminal 10 for use.

Referring to FIG. 6, the method further comprises a step of making use records of card information in the card holder terminal 10.

Referring to FIG. 6, the method further comprises a step of making use records of card information in the card provider terminal 20.

Referring to FIG. 1, the method further comprises a link step of linking respective card account having card information with the card holder account by the card holder terminal. After the card holder terminal 10 obtains the card information of a transaction card, the corresponding card account stored in the database needs to be linked with the card holder account for further use.

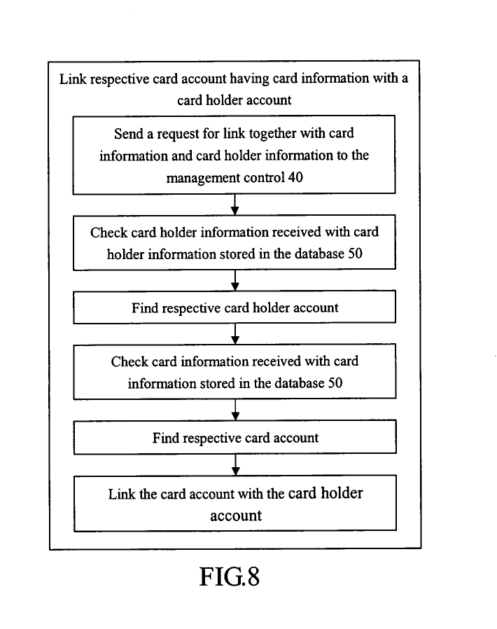

Referring to FIG. 8, the link step further comprises steps of:

sending a request for link together with card information and card holder information to the management control 40 by the card holder terminal 10;

checking card holder information sent by the card holder terminal 10 with card holder information stored in the database 50 to find respective card holder account by the account manager 42;

checking card information sent by the card holder terminal 10 with card information stored in card accounts linked with the card holder account in the database 50 to find respective card account by the account manager 42;

linking the card account with the card holder account.

Until now, a data link of a transaction card is completed.

Now, when a card holder wants to use a transaction card of a card provider, the step (c), the step (d) and step (e) will be processed.

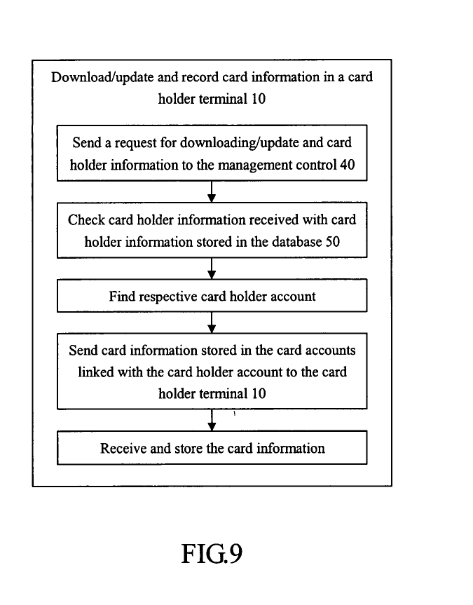

Referring to FIG. 9, in the step (d), the card information is sent together with a request for checking and the card provider information stored in the card provider terminal 10 to the management control 40 by the card provider terminal 10.

Referring to FIG. 9, the step (e) further comprises the steps of:

checking card provider information received with card provider information stored in the database 50 by the account manager 42 of the management control 40;

finding respective card provider account in the database 50; and

checking card information received with card information stored in card accounts linked with the card provider account to find respective card account.

Then a checking result will be forwarded to the card provider in the step (f) mentioned above.

The method further comprises a deposit step of transacting predetermined amount of money to respective card holder account of card holder or to one or more respective card accounts of transaction cards by the payment system 43 of the management control 40.

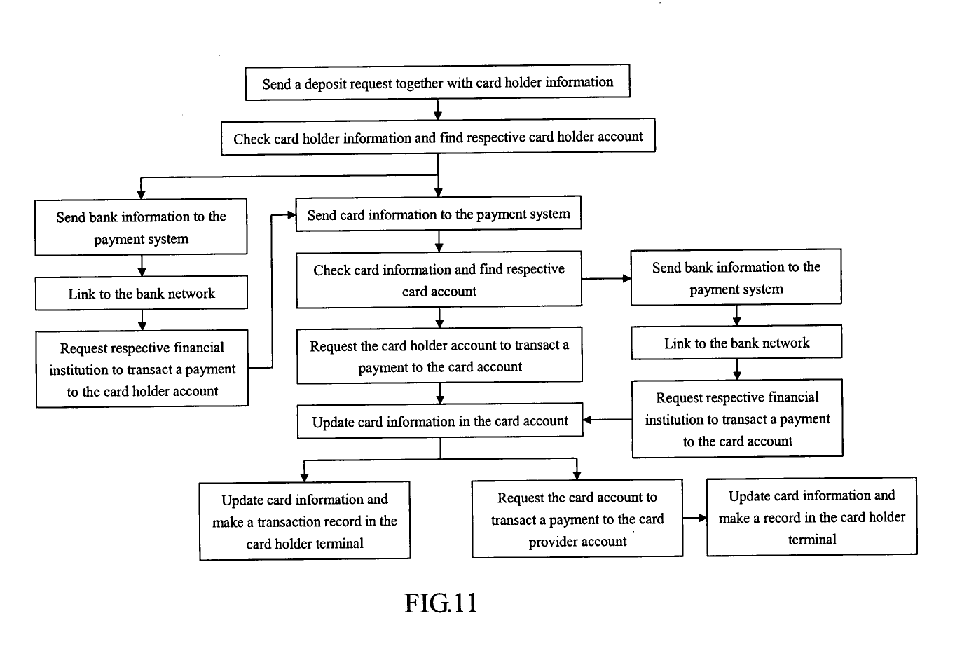

Referring to FIG. 11, the deposit step can be done in three ways to transacting predetermined amount of money from a bank account to a card holder account, or from a bank account to a card account of a card holder, or from a card holder account to a card account of the card holder.

Referring to FIG. 11, to transact predetermined amount of money from a bank account to a card holder account, the deposit step further comprises steps of:

sending a request for transacting predetermined amount of money together with card holder information and a bank account information to the management control 40 by the card holder terminal 10;

checking card holder information sent by the card holder terminal 10 with card holder information stored in the database 50 to find respective card holder account by the account manager 42 of the management control 40;

checking the bank account information and forwards the bank account information to respective bank through respective bank network by the payment system 43;

transacting predetermined amount of money from the bank account to the card holder account by the payment system 43.

Referring to FIG. 11, to transact predetermined amount of money from a bank account to a card account of a card holder, the deposit step further comprises steps of:

sending a request for transacting predetermined amount of money together with card holder information, card information and a bank account information to the management control 40 by the card holder terminal 10;

checking card holder information sent by the card holder terminal 10 with card holder information stored in the database 50 to find respective card holder account by the account manager 42 of the management control 40;

checking card information sent by the card holder terminal 10 with card information stored in card accounts linked with the card holder account in the database 50 to find respective card account by the account manager 42;

checking the bank account information and forwards the bank account information to respective bank through respective bank network by the payment system 43;

transacting predetermined amount of money from the bank account to the card account by the payment system 43.

Referring to FIG. 11, to transact predetermined amount of money from a card holder account to a card account of the card holder, the deposit step further comprises steps of:

sending a request for transacting predetermined amount of money together with card holder information and card information to the management control 40 by the card holder terminal 10;

checking card holder information sent by the card holder terminal 10 with card holder information stored in the database 50 to find respective card holder account by the account manager 42 of the management control 40;

checking card information sent by the card holder terminal 10 with card information stored in card accounts linked with the card holder account in the database 50 to find respective card account by the account manager 42;

transacting predetermined amount of money from the card holder account to the card holder account by the payment system 43.

After making a deposit to a card account or using a transaction card, or just after a period of time, or just when a card holder wants, card information stored in a card holder terminal 10 can be updated. Referring to FIG. 9, the method further comprises an update step, which comprises steps of

sending a request for downloading/update with card holder information to the management control 40 by the card holder terminal 10;

checking card holder information sent by the card holder terminal 10 with card holder information stored in the database 50 to find respective card holder account by the account manager 42;

sending card information stored in card accounts linked with the card holder account to the card holder terminal 10;

receiving and storing the card information in the card holder terminal 10.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A system for managing transaction cards, comprising one or more card holder terminals, one or more card provider terminals, a management control, a database connected with said management control and containing card information of transaction cards, and a business network linking said card holder terminals, said card provider terminals with said management control, wherein said card holder terminals is communicatively linked with said card provider terminals;
wherein said card holder terminals obtaining and storing card information of transaction cards and sending said card information to said card provider terminals;
wherein said card provider terminals receiving said card information from said card holder terminals and sending said card information to said management control;
wherein said management control receiving said card information from said card provider terminals and checking said card information with card information stored in said database, said management control sending checking results to said card provider terminals.

2. The system, as recited in claim 1, wherein said card holder terminal comprises:
a memory storing card information;
a transceiver communicatively linked with said management control and said card provider terminal, wherein said transceiver sending card information stored in said memory to said card provider terminals and/or to said database and receiving card information from said card provider terminals and/or from said database through said management control; and
a card holder manager connected with said memory and said transceiver and managing said memory and said transceiver;
wherein said card holder manager manages card information received by said transceiver to be stored in said memory;
wherein said card holder manager manages card information stored in said memory to be selected and to be sent by said transceiver with a use record of said card information recorded in said memory.

3. The system, as recited in claim 2, wherein said card holder terminal further comprises a card reader connected with said card holder manager, wherein said card reader reads card information from a transaction card and transmits said card information to said card holder manager, which further stores said card information in said memory.

4. The system, as recited in claim 3, wherein said card holder terminal further comprises a read-write device connected with said card holder manager, wherein said read-write device reads card information stored in an external memory and transmits said card information to said card holder manager, which further stores said card information in said memory;
wherein said card holder manager manages card information stored in said memory to be copied to an external memory with said read-write device.

5. The system, as recited in claim 4, wherein said card holder terminal further comprises a display component connected with said card holder manager, wherein said display component displays card information identifying cards to select from.

6. The system, as recited in claim 5, wherein said card holder terminal further comprises an input device connected with said card holder manager for inputting card holder information and/or card holder's identification information.

7. The system, as recited in claim 6, wherein said card holder manager further comprises an encrypting unit operatively linked with said transceiver for encrypting information before sending to said card provider terminal and/or said management control.

8. The system, as recited in claim 1, wherein said database contains one or more card accounts storing card information of transaction cards, one or more card provider accounts storing card provider information of the ones who give transaction cards, and one or more card holder accounts storing card holder information of the ones who are given transaction cards, wherein each card account is linked with respective card provider accounts and with respective card holder accounts.

9. The system, as recited in claim 8, wherein said management control comprises:
an information record receiving card information from said card provider terminals and storing card information in said database;
an account manager checking card information, card holder information and card provider information received with card information, card holder information and card provider information stored in said database to find respective card accounts, card holder account and card provider accounts.

10. The system, as recited in claim 9, wherein when said account manager receives a request for downloading card information sent by said card holder terminal, said account manager checks card holder information sent by said card holder terminal with card holder information stored in said database to find respective card holder account and then sends card information stored in card accounts linked with said respective card holder account to said card holder terminal, said card information downloaded from said database is substantially received and stored in said card holder terminal.

11. The system, as recited in claim 10, wherein when said card provider terminal receives card information from said card holder terminal, said card provider terminal sends a request for checking together with said card information received and card provider information to said management control, when said account manager of said management control receives said request, said account manager checks said card provider information received with card provider information stored in said database to find respective card provider account and then further checks said card information received with card information stored in card accounts linked with said card holder accounts to find said respective card account.

12. The system, as recited in claim 11, wherein said card provider terminal manages the establishment of card account in said database;
wherein said card provider terminal sends a request for establishing card account together with card information and card provider information to said management control, when said account manager of said management control receives said request, said account manager checks said card provider information received with card provider information stored in said database to find respective card provider account, said information record establishes a card account in said database, records said card information received in said card account and links said card account with said respective card provider account.

13. The system, as recited in claim 9, wherein said management control further connects with one or more bank networks, to which said card holder terminal sends a request for deposit directly or indirectly through said business network to transact predetermined amount of money to respective card holder account or to one or more respective card accounts of transaction cards, wherein said management control further comprises a payment system managing requests for deposit.

14. The system, as recited in claim 12, wherein said card holder terminal sends a request for transacting predetermined amount of money together with card holder information and a bank account information to said management control, and when said management control receives said request, said account manager checks card holder information sent by said card holder terminal with card holder information stored in said database to find respective card holder account, and said payment system checks said bank account information and forwards said bank account information to respective bank through respective bank network to transact predetermined amount of money to said card holder account.

15. The system, as recited in claim 12, wherein said card holder terminal sends a request for transacting predetermined amount of money together with card holder information, card information and a bank account information to said management control, and when said management control receives said request, said account manager checks card holder information sent by said card holder terminal with card holder information stored in said database to find respective card holder account and checks card information sent by said card holder terminal with card information stored in card accounts linked with said card holder account to find respective card account, and said payment system checks said bank account information and forwards said bank account information to respective bank through respective bank network to transact predetermined amount of money to said card account.

16. The system, as recited in claim 12, wherein said card holder terminal sends a request for transacting predetermined amount of money together with card holder information and card information to said management control, and when said management control receives said request, said account manager checks card holder information sent by said card holder terminal with card holder information stored in said database to find respective card holder account and checks card information sent by said card holder terminal with card information stored in card accounts linked with said card holder account to find respective card account, and said payment system transact predetermined amount of money from said card holder account to said card account.

17. The system, as recited in claim 9, wherein said card holder terminal comprises:
a memory storing card information;
a transceiver communicatively linked with said management control and said card provider terminal, wherein said transceiver sending card information stored in said memory to said card provider terminals and/or to said database and receiving card information from said card provider terminals and/or from said database through said management control;
a card holder manager connected with said memory and said transceiver and managing said memory and said transceiver; and
an input device connected with said card holder manager for inputting card holder information and/or card holder's identification information;
wherein said card holder manager manages card information received by said transceiver to be stored in said memory;
wherein said card holder manager manages card information stored in said memory to be selected and to be sent by said transceiver with a use record of said card information recorded in said memory.

18. The system, as recited in claim 17, wherein said card holder terminal further comprises a card reader connected with said card holder manager, wherein said card reader reads card information from a transaction card and transmits said card information to said card holder manager, which further stores said card information in said memory.

19. The system, as recited in claim 18, wherein said card holder terminal further comprises a read-write device connected with said card holder manager, wherein said read-write device reads card information stored in an external memory and transmits said card information to said card holder manager, which further stores said card information in said memory;
wherein said card holder manager manages card information stored in said memory to be copied to an external memory with said read-write device.

20. The system, as recited in claim 19, wherein said card holder terminal further comprises a display component connected with said card holder manager, wherein said display component displays card information identifying cards to select from.

21. The system, as recited in claim 20, wherein said card holder manager further comprises an encrypting unit operatively linked with said transceiver for encrypting information before sending to said card provider terminal and/or said management control.

22. The system, as recited in claim 21, wherein when said account manager receives a request for downloading card information sent by said card holder terminal, said account manager checks card holder information sent by said card holder terminal with card holder information stored in said database to find respective card holder account and then sends card information stored in card accounts linked with said respective card holder account to said card holder terminal, said card information downloaded from said database is substantially received and stored in said card holder terminal.

23. The system, as recited in claim 22, wherein when said card provider terminal receives card information from said card holder terminal, said card provider terminal sends a request for checking together with said card information received and card provider information to said management control, when said account manager of said management control receives said request, said account manager checks said card provider information received with card provider information stored in said database to find respective card provider account and then further checks said card information received with card information stored in card accounts linked with said card holder accounts to find said respective card account.

24. The system, as recited in claim 23, wherein said card provider terminal manages the establishment of card account in said database;
wherein said card provider terminal sends a request for establishing card account together with card information and card provider information to said management control, when said account manager of said management control receives said request, said account manager checks said card provider information received with card provider information stored in said database to find respective card provider account, said information record establishes a card account in said database, records said card information received in said card account and links said card account with said respective card provider account.

25. The system, as recited in claim 24, wherein said management control further connects with one or more bank networks, to which said card holder terminal sends a request for deposit directly or indirectly through said business network to transact predetermined amount of money to respective card holder account or to one or more respective card accounts of transaction cards, wherein said management control further comprises a payment system managing requests for deposit.

26. The system, as recited in claim 25, wherein said card holder terminal sends a request for transacting predetermined amount of money together with card holder information and a bank account information to said management control, and when said management control receives said request, said account manager checks card holder information sent by said card holder terminal with card holder information stored in said database to find respective card holder account, and said payment system checks said bank account information and forwards said bank account information to respective bank through respective bank network to transact predetermined amount of money to said card holder account.

27. The system, as recited in claim 25, wherein said card holder terminal sends a request for transacting predetermined amount of money together with card holder information, card information and a bank account information to said management control, and when said management control receives said request, said account manager checks card holder information sent by said card holder terminal with card holder information stored in said database to find respective card holder account and checks card information sent by said card holder terminal with card information stored in card accounts linked with said card holder account to find respective card account, and said payment system checks said bank account information and forwards said bank account information to respective bank through respective bank network to transact predetermined amount of money to said card account.

28. The system, as recited in claim 25, wherein said card holder terminal sends a request for transacting predetermined amount of money together with card holder information and card information to said management control, and when said management control receives said request, said account manager checks card holder information sent by said card holder terminal with card holder information stored in said database to find respective card holder account and checks card information sent by said card holder terminal with card information stored in card accounts linked with said card holder account to find respective card account, and said payment system transact predetermined amount of money from said card holder account to said card account.

29. A method of managing transaction cards, comprising the steps of:
(a) providing a business network;
(b) providing a database containing card information of transaction cards;
(c) sending card information stored in one or more card holder terminals to one or more card provider terminals;
(d) sending card information received to a management control through said business network by said card provider terminals;
(e) checking card information received with card information stored in said database by said management control;
(f) sending checking result to said card provider terminals by said management control.

30. The method, as recited in claim 29, wherein said method of managing transaction cards further comprises a deposit step of transacting predetermined amount of money to respective card holder account of card holder or to one or more respective card accounts of transaction cards by a payment system of said management control.

31. The method, as recited in claim 30, wherein said deposit step further comprises steps of:
sending a request for transacting predetermined amount of money together with card holder information and a bank account information to said management control by said card holder terminal;
checking card holder information sent by said card holder terminal with card holder information stored in said database to find respective card holder account by an account manager of said management control;
checking said bank account information and forwards said bank account information to respective bank through respective bank network by said payment system;
transacting predetermined amount of money to said card holder account by said payment system.

32. The method, as recited in claim 30, wherein said deposit step further comprises steps of:
sending a request for transacting predetermined amount of money together with card holder information, card information and a bank account information to said management control by said card holder terminal;
checking card holder information sent by said card holder terminal with card holder information stored in said database to find respective card holder account by an account manager of said management control;
checking card information sent by said card holder terminal with card information stored in card accounts linked with said card holder account in said database to find respective card account by said account manager;
checking said bank account information and forwards said bank account information to respective bank through respective bank network by said payment system;
transacting predetermined amount of money to said card account by said payment system.

33. The method, as recited in claim 30, wherein said deposit step further comprises steps of:
sending a request for transacting predetermined amount of money together with card holder information and card information to said management control by said card holder terminal;
checking card holder information sent by said card holder terminal with card holder information stored in said database to find respective card holder account by an account manager of said management control;
checking card information sent by said card holder terminal with card information stored in card accounts linked with said card holder account in said database to find respective card account by said account manager;
transacting predetermined amount of money from said card holder account to said card holder account by said payment system.

34. The method, as recited in claim 29, wherein in said step (d), said card information is sent together with a request for checking and card provider information stored in said card provider terminal to said management control by said card provider terminal.

35. The method, as recited in claim 34, wherein said step (e) further comprises steps of:
checking card provider information received with card provider information stored in said database by an account manager of said management control;
finding respective card provider account in said database; and
checking card information received with card information stored in card accounts linked with said card provider account to find respective card account.

36. The method, as recited in claim 35, wherein said step (c) further comprises a step (c1) of obtaining card information by said card holder terminal before said step of sending card information.

37. The method, as recited in claim 36, wherein, said method further comprises a step (b1) of uploading card information to said database through said management control by said card provider terminal between said step (b) and said step (c).

38. The method, as recited in claim 37, wherein, said method further comprises a link step of linking respective card account having card information with said card holder account by said card holder terminal.

39. The method, as recited in claim 38, wherein said step (c1) is selected from:
sending card information to said card holder terminal by said card provider terminal and storing said card information in said card holder terminal for use; or
reading card information from a transaction card with a card reader of said card holder terminal and storing said card information in said card holder terminal for use; or
reading card information stored in an external memory with a read-write device of said card holder terminal and storing acquired card information in said card holder terminal for use.

40. The method, as recited in claim 39, wherein said step (b1) further comprises steps of:
sending a request for uploading together with card information and card provider information to said management control by said card provider terminal;
checking card provider information sent by said card provider terminal with card provider information stored in said database to find respective card holder provider account by said account manager;
storing card information in a card account and linking said card account with said card provider account by an information record of said management control.

41. The method, as recited in claim 40, wherein said link step further comprises steps of:
sending a request for link together with card information and card holder information to said management control by said card holder terminal;
checking card holder information sent by said card holder terminal with card holder information stored in said database to find respective card holder account by said account manager;
checking card information sent by said card holder terminal with card information stored in card accounts linked with said card holder account in said database to find respective card account by said account manager;
linking said card account with said card holder account.

42. The method, as recited in claim 41, wherein, said method further comprises an update step, which comprises steps of:
sending a request for downloading/update with card holder information to said management control by said card holder terminal;
checking card holder information sent by said card holder terminal with card holder information stored in said database to find respective card holder account by said account manager;
sending card information stored in card accounts linked with said card holder account to said card holder terminal;
receiving and storing said card information in said card holder terminal.

43. The method, as recited in claim 42, wherein said method further comprises a step of making use records of card information in said card holder terminal.

44. The method, as recited in claim 43, wherein said method further comprises a step of making use records of card information in said card provider terminal.

45. The method, as recited in claim 44, wherein said method of managing transaction cards further comprises a deposit step of transacting predetermined amount of money to respective card holder account of card holder or to one or more respective card accounts of transaction cards by a payment system of said management control.

46. The method, as recited in claim 45, wherein said deposit step further comprises steps of:
sending a request for transacting predetermined amount of money together with card holder information and a bank account information to said management control by said card holder terminal;
checking card holder information sent by said card holder terminal with card holder information stored in said database to find respective card holder account by an account manager of said management control;
checking said bank account information and forwards said bank account information to respective bank through respective bank network by said payment system;
transacting predetermined amount of money from said bank account to said card holder account by said payment system.

47. The method, as recited in claim 45, wherein said deposit step further comprises steps of:
sending a request for transacting predetermined amount of money together with card holder information, card information and a bank account information to said management control by said card holder terminal;
checking card holder information sent by said card holder terminal with card holder information stored in said database to find respective card holder account by an account manager of said management control;
checking card information sent by said card holder terminal with card information stored in card accounts linked with said card holder account in said database to find respective card account by said account manager;
checking said bank account information and forwards said bank account information to respective bank through respective bank network by said payment system;
transacting predetermined amount of money from said bank account to said card account by said payment system.

48. The method, as recited in claim 45, wherein said deposit step further comprises steps of:
sending a request for transacting predetermined amount of money together with card holder information and card information to said management control by said card holder terminal;
checking card holder information sent by said card holder terminal with card holder information stored in said database to find respective card holder account by an account manager of said management control;
checking card information sent by said card holder terminal with card information stored in card accounts linked with said card holder account in said database to find respective card account by said account manager;
transacting predetermined amount of money from said card holder account to said card holder account by said payment system.
